(19) United States
(12) Patent Application Publication
(10) Pub. No.: US 2018/0359700 A1
(43) Pub. Date: Dec. 13, 2018

(54) TECHNIQUES AND APPARATUSES FOR IDENTIFYING PHYSICAL CELL IDENTIFIER COLLISIONS

(71) Applicant: QUALCOMM Incorporated, San Diego, CA (US)

(72) Inventors: Mohana Rao SASANAPURI, Hyderabad (IN); Narasimhan AGARAM, Hyderabad (IN); Mayank ARORA, Hyderabad (IN); Abhishek SAURABH, Hyderabad (IN)

(21) Appl. No.: 15/620,259

(22) Filed: Jun. 12, 2017

(51) Int. Cl. H04W 52/02; H04W 24/10; H04W 74/08; H04W 72/04; H04L 5/00; H04W 72/08; H04W 48/16

(52) U.S. Cl. CPC H04W 52/0206; H04W 24/10; H04W 74/0816; H04W 48/16; H04L 5/0057; H04W 72/085; H04W 72/0446

(57) ABSTRACT

A method, an apparatus, a base station, and a computer-readable medium for wireless communication are provided. In some aspects, the apparatus may configure a wireless communication device to perform a measurement associated with a particular physical cell identifier (PCI) during a particular time period, wherein the apparatus is associated with the particular PCI. In some aspects, the apparatus may configure the apparatus not to transmit during the particular time period. In some aspects, the apparatus may determine whether the wireless communication device is associated with a PCI collision based at least in part on the measurement.

### BACKGROUND

### Field

The present disclosure relates generally to communication systems, and more particularly, to techniques and apparatuses for identifying physical cell identifier (PCI) collisions.

### Background

Wireless communication systems are widely deployed to provide various telecommunication services such as telephony, video, data, messaging, and broadcasts. Typical wireless communication systems may employ multiple-access technologies capable of supporting communication with multiple users by sharing available system resources (e.g., bandwidth, transmit power). Examples of such multiple-access technologies include code division multiple access (CDMA) systems, time division multiple access (TDMA) systems, frequency division multiple access (FDMA) systems, orthogonal frequency division multiple access (OFDMA) systems, single-carrier frequency division multiple access (SC-FDMA) systems, and time division synchronous code division multiple access (TD-SCDMA) systems.

These multiple access technologies have been adopted in various telecommunication standards to provide a common protocol that enables different wireless devices to communicate on a municipal, national, regional, and even global level. An example telecommunication standard is Long Term Evolution (LTE). LTE is a set of enhancements to the Universal Mobile Telecommunications System (UMTS) mobile standard promulgated by Third Generation Partnership Project (3GPP). LTE is designed to better support mobile broadband Internet access by improving spectral efficiency, lowering costs, improving services, making use of new spectrum, and better integrating with other open standards using OFDMA on the downlink (DL), SC-FDMA on the uplink (UL), and multiple-input multiple-output (MIMO) antenna technology. However, as the demand for mobile broadband access continues to increase, there exists a need for further improvements in LTE technology. Preferably, these improvements should be applicable to other multi-access technologies and the telecommunication standards that employ these technologies.

### SUMMARY

In an aspect of the disclosure, a method, a base station, an apparatus, and a computer-readable medium are provided.

In some aspects, the method may include configuring, by a base station, a wireless communication device to perform a measurement associated with a particular physical cell identifier (PCI) during a particular time period, wherein the base station is associated with the particular PCI; configuring the base station not to transmit during the particular time period; and/or determining, by the base station, whether the wireless communication device is associated with a PCI collision based at least in part on the measurement.

In some aspects, the base station may include a memory and at least one processor coupled to the memory and configured to configure a wireless communication device to perform a measurement associated with a particular physical cell identifier (PCI) during a particular time period, wherein the base station is associated with the particular PCI; configure the base station not to transmit during the particular time period; and/or determine whether the wireless communication device is associated with a PCI collision based at least in part on the measurement.

In some aspects, the apparatus may include means for configuring a wireless communication device to perform a measurement associated with a particular physical cell identifier (PCI) during a particular time period, wherein the apparatus is associated with the particular PCI; means for configuring the apparatus not to transmit during the particular time period; and/or means for determining whether the wireless communication device is associated with a PCI collision based at least in part on the measurement.

In some aspects, the computer-readable medium may store computer executable code for wireless communication comprising code for configuring, by a base station, a wireless communication device to perform a measurement associated with a particular physical cell identifier (PCI) during a particular time period, wherein the base station is associated with the particular PCI; code for configuring the base station not to transmit during the particular time period; and/or code for determining, by the base station, whether the wireless communication device is associated with a PCI collision based at least in part on the measurement.

Aspects generally include a method, apparatus, system, computer program product, non-transitory computer-readable medium, base station, wireless communication device, and processing system as substantially described herein with reference to and as illustrated by the accompanying drawings.

The foregoing has outlined rather broadly the features and technical advantages of examples according to the disclosure in order that the detailed description that follows may be better understood. Additional features and advantages will be described hereinafter. The conception and specific examples disclosed may be readily utilized as a basis for modifying or designing other structures for carrying out the same purposes of the present disclosure. Such equivalent constructions do not depart from the scope of the appended claims. Characteristics of the concepts disclosed herein, both their organization and method of operation, together with associated advantages will be better understood from the following description when considered in connection with the accompanying figures. Each of the figures is provided for the purpose of illustration and description, and not as a definition of the limits of the claims.

### BRIEF DESCRIPTION OF THE DRAWINGS

FIG. 1 is a diagram illustrating an example of a network architecture.

FIG. 2 is a diagram illustrating an example of an access network.

FIG. 3 is a diagram illustrating an example of a DL frame structure in LTE.

FIG. 4 is a diagram illustrating an example of an UL frame structure in LTE.

FIG. 5 is a diagram illustrating an example of a radio protocol architecture for the user and control planes.

FIG. 6 is a diagram illustrating an example of an evolved Node B and user equipment in an access network.

FIGS. 7A-7C are diagrams of examples of identifying a PCI collision based at least in part on a suspended transmission mode of a serving cell.

FIG. 8 is a flow chart of a method of wireless communication.

FIG. 9 is a conceptual data flow diagram illustrating the data flow between different modules/means/components in an example apparatus.

FIG. 10 is a diagram illustrating an example of a hardware implementation for an apparatus employing a processing system.

### DETAILED DESCRIPTION

The detailed description set forth below in connection with the appended drawings is intended as a description of various configurations and is not intended to represent the configurations in which the concepts described herein may be practiced. The detailed description includes specific details for the purpose of providing a thorough understanding of various concepts. However, it will be apparent to those skilled in the art that these concepts may be practiced without these specific details. In some instances, well known structures and components are shown in block diagram form in order to avoid obscuring such concepts.

Several aspects of telecommunication systems will now be presented with reference to various apparatus and methods. These apparatus and methods will be described in the following detailed description and illustrated in the accompanying drawings by various blocks, modules, components, circuits, steps, processes, algorithms, etc. (collectively referred to as “elements”). These elements may be implemented using electronic hardware, computer software, or any combination thereof. Whether such elements are implemented as hardware or software depends upon the particular application and design constraints imposed on the overall system.

By way of example, an element, or any portion of an element, or any combination of elements may be implemented with a “processing system” that includes one or more processors. Examples of processors include microprocessors, microcontrollers, digital signal processors (DSPs), field programmable gate arrays (FPGAs), programmable logic devices (PLDs), state machines, gated logic, discrete hardware circuits, and other suitable hardware configured to perform the various functionality described throughout this disclosure. One or more processors in the processing system may execute software. Software shall be construed broadly to mean instructions, instruction sets, code, code segments, program code, programs, subprograms, software modules, applications, software applications, software packages, routines, subroutines, objects, executables, threads of execution, procedures, functions, etc., whether referred to as software, firmware, middleware, microcode, hardware description language, or otherwise.

Accordingly, in one or more example embodiments, the functions described may be implemented in hardware, software, firmware, or any combination thereof. If implemented in software, the functions may be stored on or encoded as one or more instructions or code on a computer-readable medium. Computer-readable media includes computer storage media. Storage media may be any available media that can be accessed by a computer. By way of example, and not limitation, such computer-readable media can comprise a random-access memory (RAM), a read-only memory (ROM), an electrically erasable programmable ROM (EEPROM), compact disk ROM (CD-ROM) or other optical disk storage, magnetic disk storage or other magnetic storage devices, combinations of the aforementioned types of computer-readable media, or any other medium that can be used to store computer executable code in the form of instructions or data structures that can be accessed by a computer.

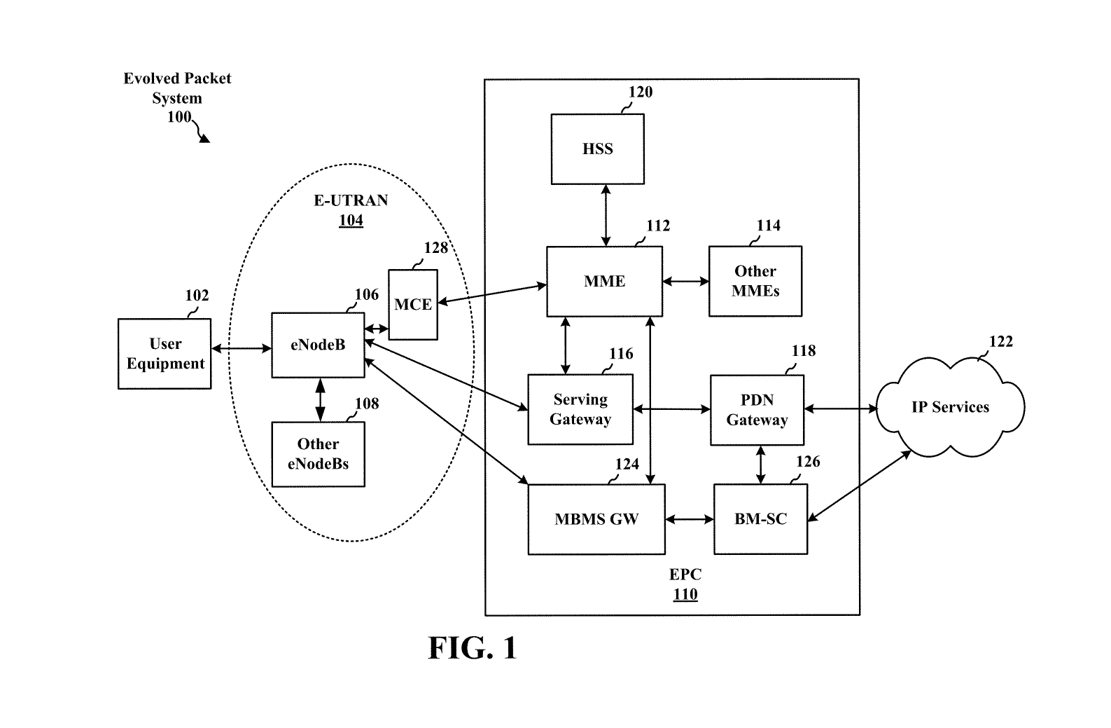

FIG. 1 is a diagram illustrating an LTE network architecture 100. The LTE network architecture 100 may be referred to as an Evolved Packet System (EPS) 100. The EPS 100 may include one or more user equipment (UE) 102, an Evolved UMTS Terrestrial Radio Access Network (E-UTRAN) 104, an Evolved Packet Core (EPC) 110, and an Operator's Internet Protocol (IP) Services 122. The EPS can interconnect with other access networks, but for simplicity those entities/interfaces are not shown. As shown, the EPS provides packet-switched services, however, as those skilled in the art will readily appreciate, the various concepts presented throughout this disclosure may be extended to networks providing circuit-switched services.

The E-UTRAN includes the evolved Node B (eNB) 106 and other eNBs 108, and may include a Multicast Coordination Entity (MCE) 128. The eNB 106 provides user and control planes protocol terminations toward the UE 102. The eNB 106 may be connected to the other eNBs 108 via a backhaul (e.g., an X2 interface). The MCE 128 allocates time/frequency radio resources for evolved Multimedia Broadcast Multicast Service (MBMS) (eMBMS), and determines the radio configuration (e.g., a modulation and coding scheme (MCS)) for the eMBMS. The MCE 128 may be a separate entity or part of the eNB 106. The eNB 106 may also be referred to as a base station, a Node B, an access point, a base transceiver station, a radio base station, a radio transceiver, a transceiver function, a basic service set (BSS), an extended service set (ESS), or some other suitable terminology. The eNB 106 provides an access point to the EPC 110 for a UE 102. Examples of UEs 102 include a cellular phone, a smart phone, a session initiation protocol (SIP) phone, a laptop, a personal digital assistant (PDA), a satellite radio, a global positioning system, a multimedia device, a video device, a digital audio player (e.g., MP3 player), a camera, a game console, a tablet, or any other similar functioning device. The UE 102 may also be referred to by those skilled in the art as a mobile station, a subscriber station, a mobile unit, a subscriber unit, a wireless unit, a remote unit, a mobile device, a wireless device, a wireless communications device, a remote device, a mobile subscriber station, an access terminal, a mobile terminal, a wireless terminal, a remote terminal, a handset, a user agent, a mobile client, a client, or some other suitable terminology.

The eNB 106 is connected to the EPC 110. The EPC 110 may include a Mobility Management Entity (MME) 112, a Home Subscriber Server (HSS) 120, other MMEs 114, a Serving Gateway 116, a Multimedia Broadcast Multicast Service (MBMS) Gateway 124, a Broadcast Multicast Service Center (BM-SC) 126, and a Packet Data Network (PDN) Gateway 118. The MME 112 is the control node that processes the signaling between the UE 102 and the EPC 110. Generally, the MME 112 provides bearer and connection management. All user IP packets are transferred through the Serving Gateway 116, which itself is connected to the PDN Gateway 118. The PDN Gateway 118 provides UE IP address allocation as well as other functions. The PDN Gateway 118 and the BM-SC 126 are connected to the IP Services 122. The IP Services 122 may include the Internet, an intranet, an IP Multimedia Subsystem (IMS), a PS Streaming Service (PSS), and/or other IP services. The BM-SC 126 may provide functions for MBMS user service provisioning and delivery. The BM-SC 126 may serve as an entry point for content provider MBMS transmission, may be used to authorize and initiate MBMS Bearer Services within a PLMN, and may be used to schedule and deliver MBMS transmissions. The MBMS Gateway 124 may be used to distribute MBMS traffic to the eNBs (e.g., 106, 108) belonging to a Multicast Broadcast Single Frequency Network (MBSFN) area broadcasting a particular service, and may be responsible for session management (start/stop) and for collecting eMBMS related charging information.

FIG. 1 is provided as an example. Other examples are possible and may differ from what was described in connection with FIG. 1.

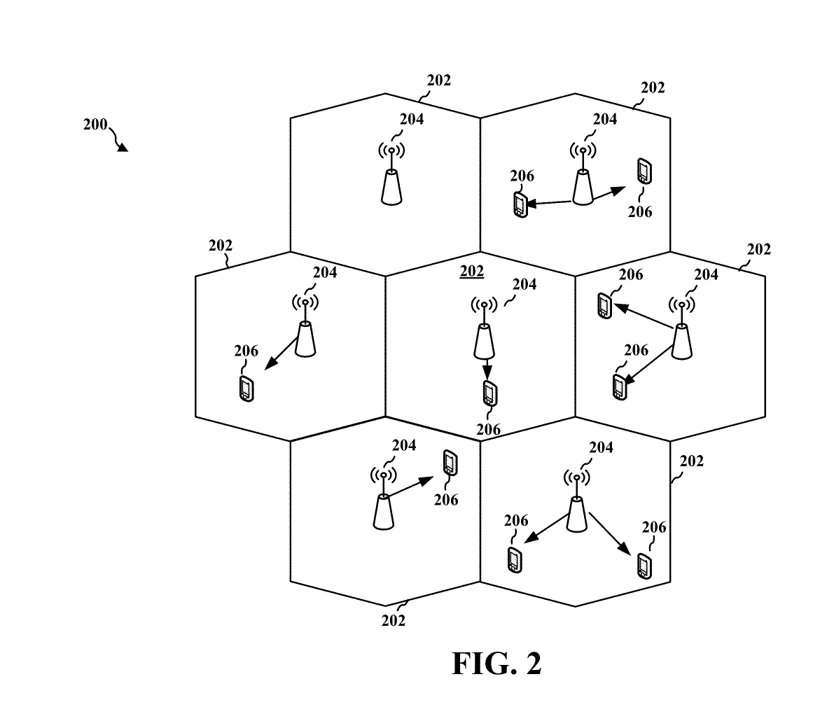

FIG. 2 is a diagram illustrating an example of an access network 200 in an LTE network architecture. In this example, the access network 200 is divided into a number of cellular regions (cells) 202. One or more lower power class eNBs 208 may have cellular regions 210 that overlap with one or more of the cells 202. The lower power class eNB 208 may be a femto cell (e.g., home eNB (HeNB)), pico cell, micro cell, or remote radio head (RRH). The macro eNBs 204 are each assigned to a respective cell 202 and are configured to provide an access point to the EPC 110 for all the UEs 206 in the cells 202. There is no centralized controller in this example of an access network 200, but a centralized controller may be used in alternative configurations. The eNBs 204 are responsible for all radio related functions including radio bearer control, admission control, mobility control, scheduling, security, and connectivity to the Serving Gateway 116. An eNB may support one or multiple (e.g., three) cells (also referred to as a sectors). The term “cell” can refer to the smallest coverage area of an eNB and/or an eNB subsystem serving a particular coverage area. Further, the terms “eNB,” “base station,” and “cell” may be used interchangeably herein.

The modulation and multiple access scheme employed by the access network 200 may vary depending on the particular telecommunications standard being deployed. In LTE applications, OFDM is used on the DL and SC-FDMA is used on the UL to support both frequency division duplex (FDD) and time division duplex (TDD). As those skilled in the art will readily appreciate from the detailed description to follow, the various concepts presented herein are well suited for LTE applications. However, these concepts may be readily extended to other telecommunication standards employing other modulation and multiple access techniques. By way of example, these concepts may be extended to Evolution-Data Optimized (EV-DO) or Ultra Mobile Broadband (UMB). EV-DO and UMB are air interface standards promulgated by the 3rd Generation Partnership Project 2 (3GPP2) as part of the CDMA2000 family of standards and employs CDMA to provide broadband Internet access to mobile stations. These concepts may also be extended to Universal Terrestrial Radio Access (UTRA) employing Wideband-CDMA (W-CDMA) and other variants of CDMA, such as TD-SCDMA; Global System for Mobile Communications (GSM) employing TDMA; and Evolved UTRA (E-UTRA), IEEE 802.11 (Wi-Fi), IEEE 802.16 (WiMAX), IEEE 802.20, and Flash-OFDM employing OFDMA. UTRA, E-UTRA, UMTS, LTE and GSM are described in documents from the 3GPP organization. CDMA2000 and UMB are described in documents from the 3GPP2 organization. The actual wireless communication standard and the multiple access technology employed will depend on the specific application and the overall design constraints imposed on the system.

The eNBs 204 may have multiple antennas supporting MIMO technology. The use of MIMO technology enables the eNBs 204 to exploit the spatial domain to support spatial multiplexing, beamforming, and transmit diversity. Spatial multiplexing may be used to transmit different streams of data simultaneously on the same frequency. The data streams may be transmitted to a single UE 206 to increase the data rate or to multiple UEs 206 to increase the overall system capacity. This is achieved by spatially precoding each data stream (i.e., applying a scaling of an amplitude and a phase) and then transmitting each spatially precoded stream through multiple transmit antennas on the DL. The spatially precoded data streams arrive at the UE(s) 206 with different spatial signatures, which enables each of the UE(s) 206 to recover the one or more data streams destined for that UE 206. On the UL, each UE 206 transmits a spatially precoded data stream, which enables the eNB 204 to identify the source of each spatially precoded data stream.

Spatial multiplexing is generally used when channel conditions are good. When channel conditions are less favorable, beamforming may be used to focus the transmission energy in one or more directions. This may be achieved by spatially precoding the data for transmission through multiple antennas. To achieve good coverage at the edges of the cell, a single stream beamforming transmission may be used in combination with transmit diversity.

In the detailed description that follows, various aspects of an access network will be described with reference to a MIMO system supporting OFDM on the DL. OFDM is a spread-spectrum technique that modulates data over a number of subcarriers within an OFDM symbol. The subcarriers are spaced apart at precise frequencies. The spacing provides “orthogonality” that enables a receiver to recover the data from the subcarriers. In the time domain, a guard interval (e.g., cyclic prefix) may be added to each OFDM symbol to combat inter-OFDM-symbol interference. The UL may use SC-FDMA in the form of a DFT-spread OFDM signal to compensate for high peak-to-average power ratio (PAPR).

FIG. 2 is provided as an example. Other examples are possible and may differ from what was described in connection with FIG. 2.

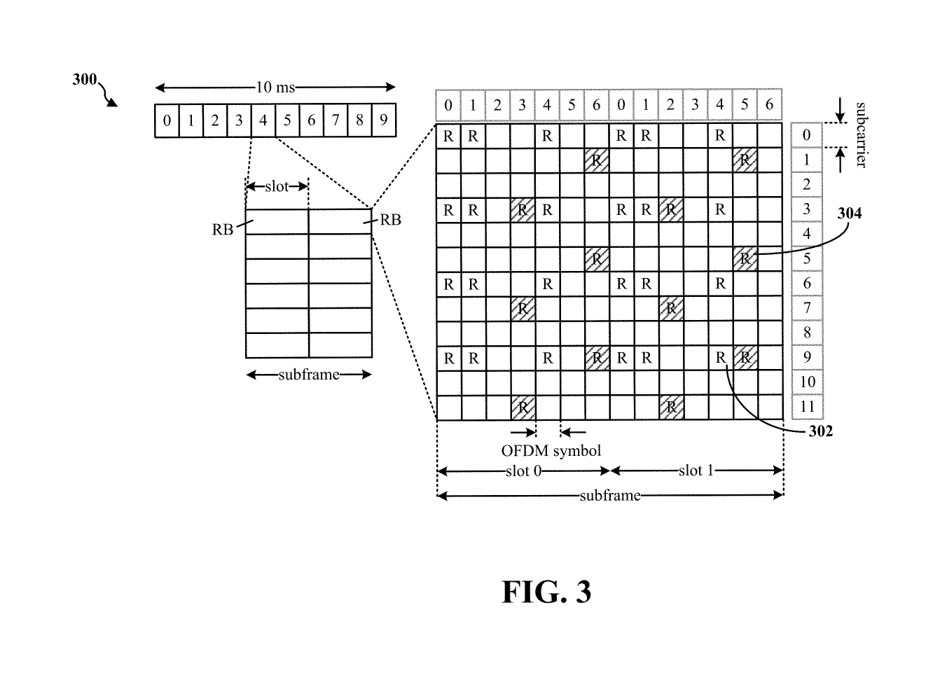

FIG. 3 is a diagram 300 illustrating an example of a DL frame structure in LTE. A frame (10 ms) may be divided into 10 equally sized sub-frames. Each sub-frame may include two consecutive time slots. A resource grid may be used to represent two time slots, each time slot including a resource block. The resource grid is divided into multiple resource elements. In LTE, for a normal cyclic prefix, a resource block contains 12 consecutive subcarriers in the frequency domain and 7 consecutive OFDM symbols in the time domain, for a total of 84 resource elements. For an extended cyclic prefix, a resource block contains 12 consecutive subcarriers in the frequency domain and 6 consecutive OFDM symbols in the time domain, for a total of 72 resource elements. Some of the resource elements, indicated as R 302, 304, include DL reference signals (DL-RS). The DL-RS include Cell-specific RS (CRS) (also sometimes called common RS) 302 and UE-specific RS (UE-RS) 304. UE-RS 304 are transmitted on the resource blocks upon which the corresponding physical DL shared channel (PDSCH) is mapped. The number of bits carried by each resource element depends on the modulation scheme. Thus, the more resource blocks that a UE receives and the higher the modulation scheme, the higher the data rate for the UE.

FIG. 3 is provided as an example. Other examples are possible and may differ from what was described in connection with FIG. 3.

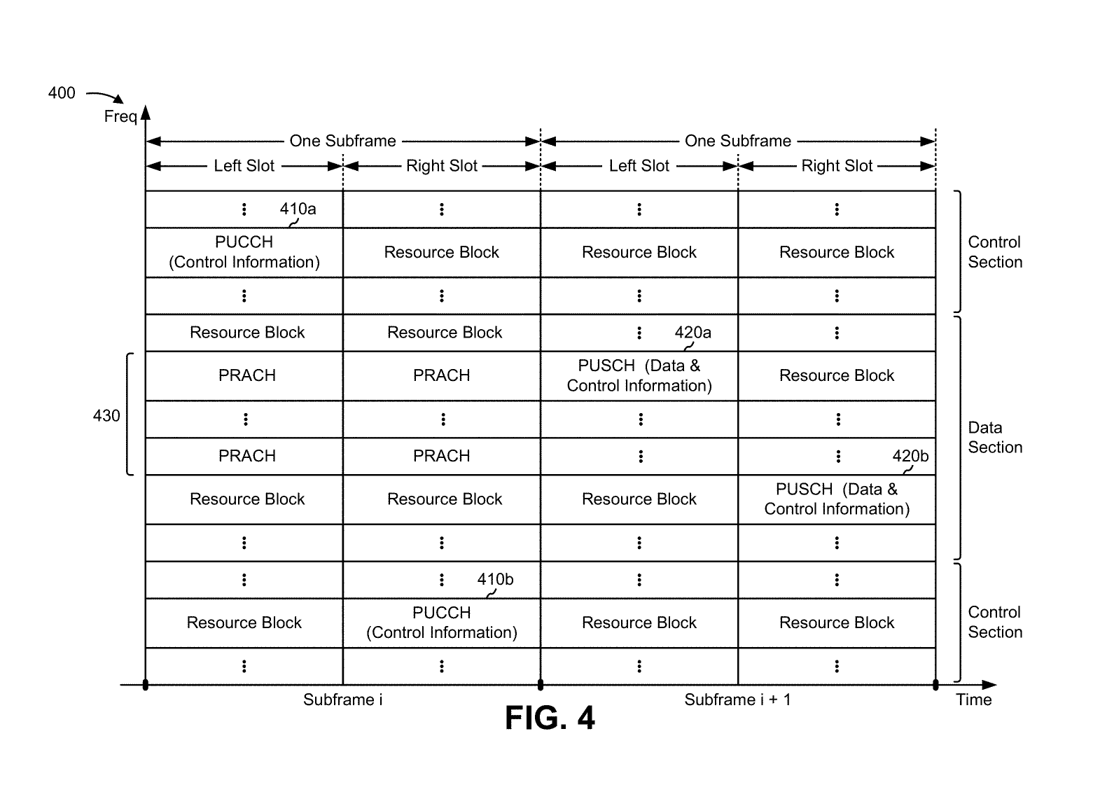

FIG. 4 is a diagram 400 illustrating an example of an UL frame structure in LTE. The available resource blocks for the UL may be partitioned into a data section and a control section. The control section may be formed at the two edges of the system bandwidth and may have a configurable size. The resource blocks in the control section may be assigned to UEs for transmission of control information. The data section may include all resource blocks not included in the control section. The UL frame structure results in the data section including contiguous subcarriers, which may allow a single UE to be assigned all of the contiguous subcarriers in the data section.

A UE may be assigned resource blocks 410a, 410b in the control section to transmit control information to an eNB. The UE may also be assigned resource blocks 420a, 420b in the data section to transmit data to the eNB. The UE may transmit control information in a physical UL control channel (PUCCH) on the assigned resource blocks in the control section. The UE may transmit data or both data and control information in a physical UL shared channel (PUSCH) on the assigned resource blocks in the data section. A UL transmission may span both slots of a sub-frame and may hop across frequency.

A set of resource blocks may be used to perform initial system access and achieve UL synchronization in a physical random access channel (PRACH) 430. The PRACH 430 carries a random sequence and cannot carry any UL data/signaling. Each random access preamble occupies a bandwidth corresponding to six consecutive resource blocks. The starting frequency is specified by the network. That is, the transmission of the random access preamble is restricted to certain time and frequency resources. There is no frequency hopping for the PRACH. The PRACH attempt is carried in a single sub-frame (1 ms) or in a sequence of few contiguous sub-frames and a UE can make a single PRACH attempt per frame (10 ms).

FIG. 4 is provided as an example. Other examples are possible and may differ from what was described in connection with FIG. 4.

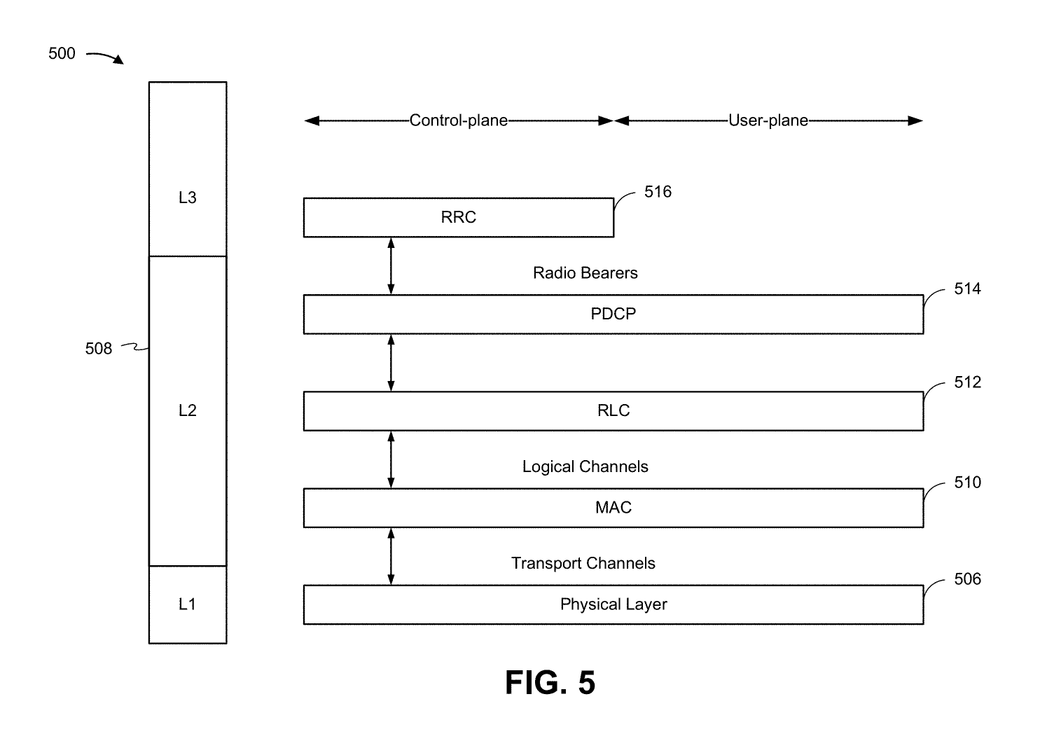

FIG. 5 is a diagram 500 illustrating an example of a radio protocol architecture for the user and control planes in LTE. The radio protocol architecture for the UE and the eNB is shown with three layers: Layer 1, Layer 2, and Layer 3. Layer 1 (L1 layer) is the lowest layer and implements various physical layer signal processing functions. The L1 layer will be referred to herein as the physical layer 506. Layer 2 (L2 layer) 508 is above the physical layer 506 and is responsible for the link between the UE and eNB over the physical layer 506.

In the user plane, the L2 layer 508 includes a media access control (MAC) sublayer 510, a radio link control (RLC) sublayer 512, and a packet data convergence protocol (PDCP) sublayer 514, which are terminated at the eNB on the network side. Although not shown, the UE may have several upper layers above the L2 layer 508 including a network layer (e.g., IP layer) that is terminated at the PDN Gateway 118 on the network side, and an application layer that is terminated at the other end of the connection (e.g., far end UE, server, etc.).

The PDCP sublayer 514 provides multiplexing between different radio bearers and logical channels. The PDCP sublayer 514 also provides header compression for upper layer data packets to reduce radio transmission overhead, security by ciphering the data packets, and handover support for UEs between eNBs. The RLC sublayer 512 provides segmentation and reassembly of upper layer data packets, retransmission of lost data packets, and reordering of data packets to compensate for out-of-order reception due to hybrid automatic repeat request (HARQ). The MAC sublayer 510 provides multiplexing between logical and transport channels. The MAC sublayer 510 is also responsible for allocating the various radio resources (e.g., resource blocks) in one cell among the UEs. The MAC sublayer 510 is also responsible for HARQ operations.

In the control plane, the radio protocol architecture for the UE and eNB is substantially the same for the physical layer 506 and the L2 layer 508 with the exception that there is no header compression function for the control plane. The control plane also includes a radio resource control (RRC) sublayer 516 in Layer 3 (L3 layer). The RRC sublayer 516 is responsible for obtaining radio resources (e.g., radio bearers) and for configuring the lower layers using RRC signaling between the eNB and the UE.

FIG. 5 is provided as an example. Other examples are possible and may differ from what was described in connection with FIG. 5.

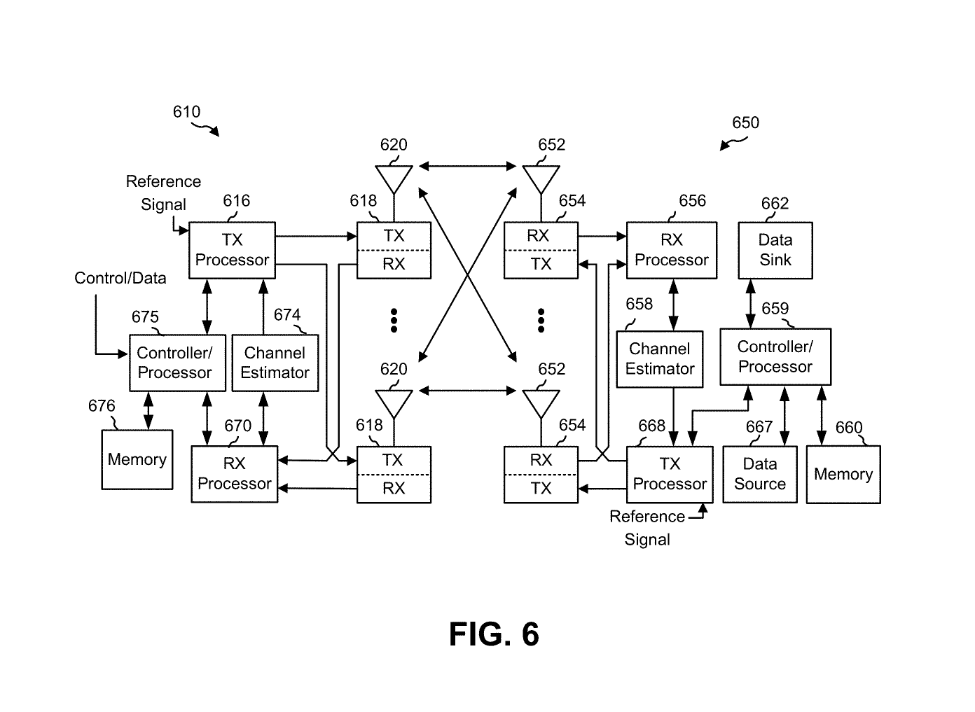

FIG. 6 is a block diagram of an eNB 610 in communication with a UE 650 in an access network. In the DL, upper layer packets from the core network are provided to a controller/processor 675. The controller/processor 675 implements the functionality of the L2 layer. In the DL, the controller/processor 675 provides header compression, ciphering, packet segmentation and reordering, multiplexing between logical and transport channels, and radio resource allocations to the UE 650 based at least in part on various priority metrics. The controller/processor 675 is also responsible for HARQ operations, retransmission of lost packets, and signaling to the UE 650.

The transmit (TX) processor 616 implements various signal processing functions for the L1 layer (i.e., physical layer). The signal processing functions include coding and interleaving to facilitate forward error correction (FEC) at the UE 650 and mapping to signal constellations based at least in part on various modulation schemes (e.g., binary phase-shift keying (BPSK), quadrature phase-shift keying (QPSK), M-phase-shift keying (M-PSK), M-quadrature amplitude modulation (M-QAM)). The coded and modulated symbols are then split into parallel streams. Each stream is then mapped to an OFDM subcarrier, multiplexed with a reference signal (e.g., pilot) in the time and/or frequency domain, and then combined together using an Inverse Fast Fourier Transform (IFFT) to produce a physical channel carrying a time domain OFDM symbol stream. The OFDM stream is spatially precoded to produce multiple spatial streams. Channel estimates from a channel estimator 674 may be used to determine the coding and modulation scheme, as well as for spatial processing. The channel estimate may be derived from a reference signal and/or channel condition feedback transmitted by the UE 650. Each spatial stream may then be provided to a different antenna 620 via a separate transmitter 618TX. Each transmitter 618TX may modulate an RF carrier with a respective spatial stream for transmission.

At the UE 650, each receiver 654RX receives a signal through its respective antenna 652. Each receiver 654RX recovers information modulated onto an RF carrier and provides the information to the receive (RX) processor 656. The RX processor 656 implements various signal processing functions of the L1 layer. The RX processor 656 may perform spatial processing on the information to recover any spatial streams destined for the UE 650. If multiple spatial streams are destined for the UE 650, they may be combined by the RX processor 656 into a single OFDM symbol stream. The RX processor 656 then converts the OFDM symbol stream from the time-domain to the frequency domain using a Fast Fourier Transform (FFT). The frequency domain signal comprises a separate OFDM symbol stream for each subcarrier of the OFDM signal. The symbols on each subcarrier, and the reference signal, are recovered and demodulated by determining the most likely signal constellation points transmitted by the eNB 610. These soft decisions may be based at least in part on channel estimates computed by the channel estimator 658. The soft decisions are then decoded and deinterleaved to recover the data and control signals that were originally transmitted by the eNB 610 on the physical channel. The data and control signals are then provided to the controller/processor 659.

The controller/processor 659 implements the L2 layer. The controller/processor can be associated with a memory 660 that stores program codes and data. The memory 660 may be referred to as a computer-readable medium. In the UL, the controller/processor 659 provides demultiplexing between transport and logical channels, packet reassembly, deciphering, header decompression, control signal processing to recover upper layer packets from the core network. The upper layer packets are then provided to a data sink 662, which represents all the protocol layers above the L2 layer. Various control signals may also be provided to the data sink 662 for L3 processing. The controller/processor 659 is also responsible for error detection using an acknowledgement (ACK) and/or negative acknowledgement (NACK) protocol to support HARQ operations.

In the UL, a data source 667 is used to provide upper layer packets to the controller/processor 659. The data source 667 represents all protocol layers above the L2 layer. Similar to the functionality described in connection with the DL transmission by the eNB 610, the controller/processor 659 implements the L2 layer for the user plane and the control plane by providing header compression, ciphering, packet segmentation and reordering, and multiplexing between logical and transport channels based at least in part on radio resource allocations by the eNB 610. The controller/processor 659 is also responsible for HARQ operations, retransmission of lost packets, and signaling to the eNB 610.

Channel estimates derived by a channel estimator 658 from a reference signal or feedback transmitted by the eNB 610 may be used by the TX processor 668 to select the appropriate coding and modulation schemes, and to facilitate spatial processing. The spatial streams generated by the TX processor 668 may be provided to different antenna 652 via separate transmitters 654TX. Each transmitter 654TX may modulate an RF carrier with a respective spatial stream for transmission.

The UL transmission is processed at the eNB 610 in a manner similar to that described in connection with the receiver function at the UE 650. Each receiver 618RX receives a signal through its respective antenna 620. Each receiver 618RX recovers information modulated onto an RF carrier and provides the information to a RX processor 670. The RX processor 670 may implement the L1 layer.

The controller/processor 675 implements the L2 layer. The controller/processor 675 can be associated with a memory 676 that stores program codes and data. The memory 676 may be referred to as a computer-readable medium. In the UL, the controller/processor 675 provides demultiplexing between transport and logical channels, packet reassembly, deciphering, header decompression, control signal processing to recover upper layer packets from the UE 650. Upper layer packets from the controller/processor 675 may be provided to the core network. The controller/processor 675 is also responsible for error detection using an ACK and/or NACK protocol to support HARQ operations.

FIG. 6 is provided as an example. Other examples are possible and may differ from what was described in connection with FIG. 6.

An eNB (e.g., the eNB 106, 204) may provide one or more cells that may be associated with respective physical cell identifiers (PCIs). A PCI may identify a corresponding cell in the physical layer, and may be used by a UE to decode traffic provided via the corresponding cell. In some aspects, a PCI may be selected from a pool of approximately 500 values, and some or all of these values may need to be reused in the network. Thus, in areas of dense deployment, some confusion may occur when two or more cells, associated with the same PCI, overlap. A PCI collision occurs when a UE encounters two overlapping cells with the same PCI. In some cases, such as a dense femtocell deployment, the PCI may be selected from a smaller pool of possible values, such as 5 values, 10 values, or the like, which may lead to increased rates of PCI collision. PCI collision may cause failure of decoding of blocks of network traffic, so it is beneficial to detect PCI collision and reduce the occurrence of PCI collision (e.g., by resetting one of the overlapping cells so anew PCI is assigned).

One method of detecting PCI collision uses a combination of a downlink block error rate (BLER) and a channel quality indicator (CQI) value to detect PCI collision. This method may detect PCI collision when the BLER is high (indicating many errors) and the CQI is high (indicating good channel quality). However, this method creates false positives in some cases.

Techniques and apparatuses described herein provide detection of PCI collision with a lower false positive rate than the BLER/CQI approach described above. For example, a serving BS (e.g., eNB) may determine that PCI collision may be occurring with regard to a UE covered by the serving BS (e.g., based at least in part on a BLER/CQI test and/or the like). Assume that the serving BS and a colliding BS are both associated with a particular PCI. To determine whether PCI collision is occurring, the serving BS may configure the UE to perform measurements for the particular PCI during a particular set of subframes. The serving BS may enter suspended transmission mode (STX) during and/or around the particular set of subframes so that the serving BS is not transmitting during and around the set of subframes. If a signal power identified by the measurements satisfies a threshold value, the serving BS determines that the colliding cell is transmitting with the same PCI during the set of subframes, indicating that PCI collision is occurring. In this way, by combining the STX mode and the measurement of the particular PCI during the particular subframes, the serving BS identifies PCI collisions with a lower false positive rate than other PCI collision detection approaches.

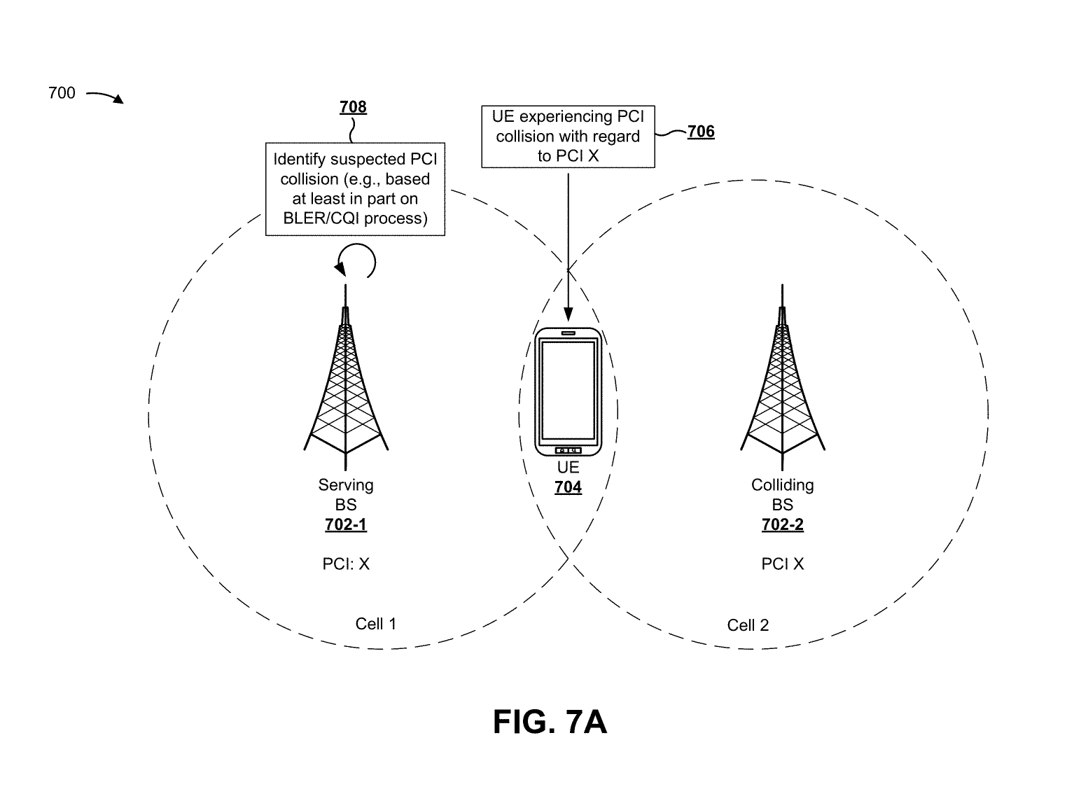

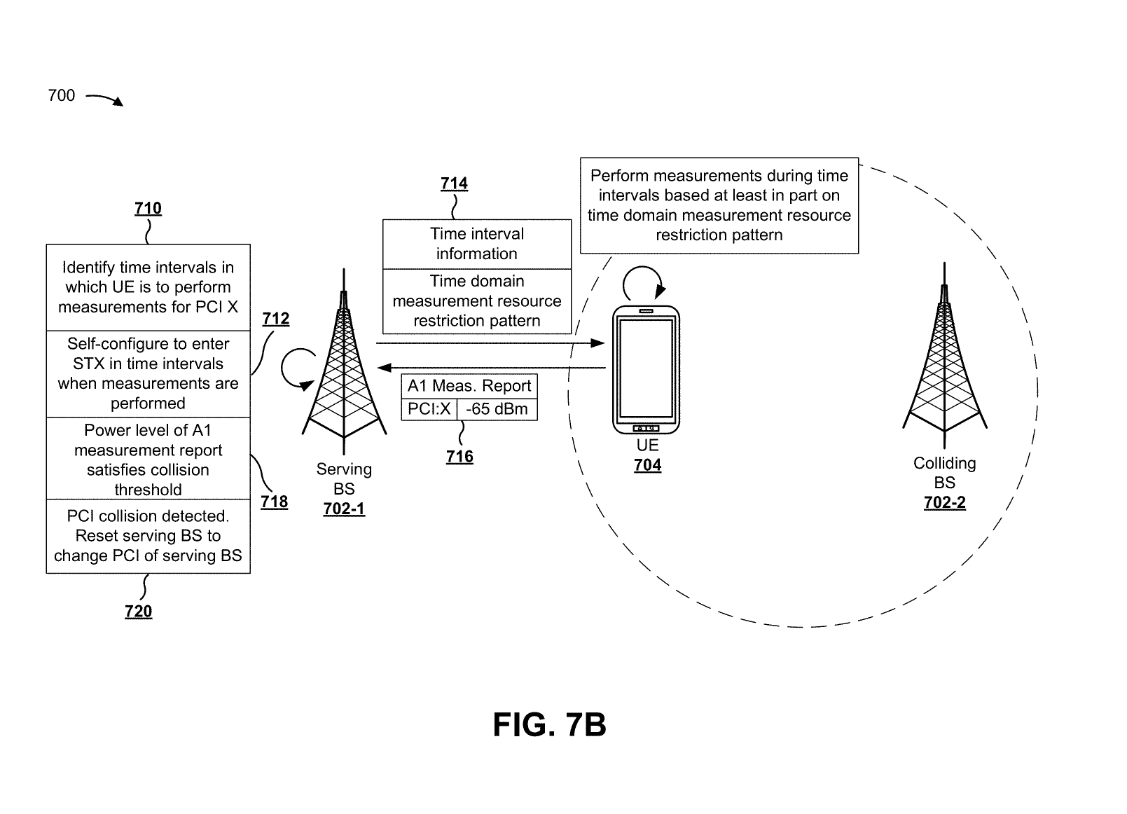

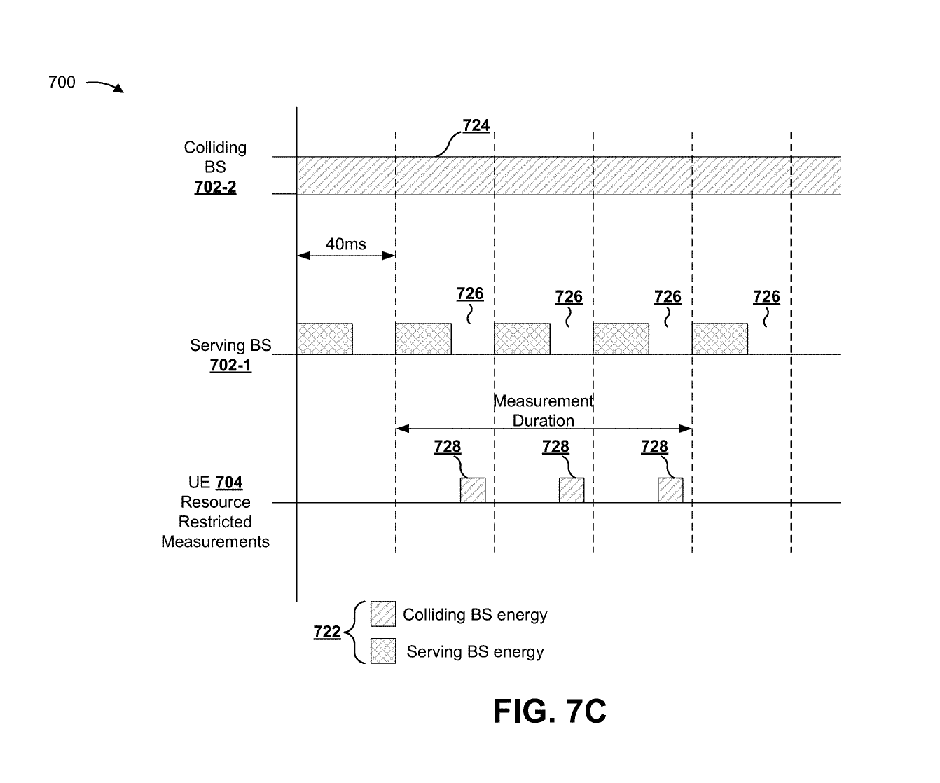

FIGS. 7A-7C are diagrams of examples 700 of identifying a PCI collision based at least in part on a suspended transmission mode of a serving cell. As shown, FIGS. 7A-7C include a serving BS 702-1 and a colliding BS 702-2. BS 702-1 and 702-2 may include, for example, eNB 106, 204, 610, apparatus 902/902′, and/or the like. As further shown, the serving BS 702-1 and the colliding BS 702-2 are associated with a PCI of X. In other words, the serving BS 702-1 and the colliding BS 702-4 are associated with the same PCI.

As further shown, a UE 704 (e.g., UE 102, 206, 650) is covered by the serving BS 702-1 (e.g., cell 1 associated with the PCI of X) and the colliding BS 702-2 (e.g., cell 2 associated with the PCI of X). As shown by reference number 706, since the UE 704 is covered by two cells with the same PCI, the UE 704 is experiencing a PCI collision with regard to PCI X shared by cell 1 and cell 2. Therefore, the UE 704 may fail to perform proper signal synchronization or decoding.

As shown by reference number 708, the serving BS 702-1 may identify a suspected PCI collision associated with the UE 704. For example, the serving BS 702-1 may identify the suspected PCI collision based at least in part on a PCI collision detection process, such as the CQI/BLER process described above or a similar process. Additionally, or alternatively, the serving BS 702-1 may identify the suspected PCI collision based at least in part on a geometry or location of the colliding BS 702-2. Additionally, or alternatively, the serving BS 702-1 may identify the suspected PCI collision based at least in part on information received from another device, such as a network administrator device, a self-organizing network (SON) system, and/or the like.

As shown in FIG. 7B, and by reference number 710, the serving BS 702-1 may identify time intervals in which the UE 704 is to determine measurements regarding PCI X. For example, the time intervals may include particular subframes, particular groups of subframes, and/or the like. In some aspects, the time intervals may be periodic and/or repeating. In some aspects, the time intervals may be uniform in length.

As shown by reference number 712, the serving BS 702-1 may configure the serving BS 702-1 to enter suspended transmission (STX) mode during the time intervals in which the measurements are to be performed. For example, the serving BS 702-1 may not transmit during the time intervals in which the measurements are to be performed. By not transmitting during the time intervals, the serving BS 702 ensures that signals received by the UE 704 during the time intervals that are associated with the PCI of X are transmitted by a colliding BS (e.g., the BS 702-2).

In some aspects, the serving BS 702-1 may select particular subframes in which to enter STX. For example, the serving BS 702-1 may select subframes so that STX of an adjacent BS does not conflict with the STX of the serving BS 702-1. Additionally, or alternatively, the serving BS 702-1 may randomize selection of the subframes so that STX of an adjacent BS is unlikely to conflict with the STX of the serving BS 702-1.

As shown by reference number 714, the serving BS 702-1 may provide time interval information to the UE 704. For example, the time interval information may be provided as radio resource control (RRC) information. As further shown, the time interval information may identify a time domain measurement resource restriction pattern to the UE 704. The time domain measurement resource restriction pattern may identify particular subframes in which the UE 704 is to perform the measurements. For example, UEs that are capable of performing inter-cell interference cancellation radio link monitoring (ICIC RLM) as defined in Release 10 of the 3GPP specification may be configurable to perform measurements in particular subframes based at least in part on the time domain measurement resource restriction pattern. As a more particular example, the serving BS 702-1 may provide a bitmap that includes values identifying subframes in which the UE 704 is to perform measurements. In some aspects, the time domain measurement resource restriction pattern may be included in a feature group indicator (e.g., feature group indicator 115 of Release 10) and/or an RRC configuration message for the UE 804 (e.g., that is defined based at least in part on Release 10 and/or ICIC RLM).

In some aspects, the serving BS 702-1 may select the UE 704 to perform the measurements based at least in part on a characteristic the UE 704. For example, the serving BS 702-1 may select the UE 704 to perform the measurements based at least in part on the UE 704 being configurable to perform the measurements in particular subframes (e.g., based at least in part on the UE 704 being ICIC RLM compatible). Additionally, or alternatively, the serving BS 702-1 may select a group of UEs 704 to perform the measurements, which may improve accuracy of PCI collision detection. Additionally, or alternatively, the serving BS 702-1 may select one or more UEs 704 based at least in part on BLERs of the one or more UEs 704. For example, the serving BS 702-1 may select a UE 704 to perform a measurement when a BLER of the UE 704 satisfies a threshold.

As further shown, the UE 704 may perform the measurements during the time intervals based at least in part on the time domain resource restriction pattern. For example, the measurements may include a reference signal received power (RSRP) value, a reference signal received quality (RSRQ) value, a radio link monitoring value, and/or the like.

As shown by reference number 716, the UE 704 may provide a measurement report to the serving BS 704-1. The measurement report may identify one or more values of the measurements performed during the time intervals. Here, the measurement report is an A1 measurement report. For example, the UE 704 may generate an A1 measurement report when a value of a measurement satisfies an A1 measurement threshold. In some aspects, the A1 measurement threshold may be configured so that the A1 measurement report is triggered when the UE 704 detects any signal associated with the PCI of X. For example, the A1 measurement threshold may be set to a minimum sensitivity of the UE 704. As further shown, the A1 measurement report identifies a power level of −65 dBm associated with the PCI of X.

As shown by reference number 718, the serving BS 702 may determine that the power level identified by the A1 measurement report (e.g., −65 dBm) satisfies a collision threshold. For example, when the power level satisfies the collision threshold, the serving BS 702-1 may identify a PCI collision associated with the UE 704. Additionally, or alternatively, when the power level satisfies the collision threshold, the serving BS 702-1 may determine that an action should be performed with regard to the PCI collision associated with the UE 704. For example, in some cases, the serving BS 702-1 may determine that PCI collision is occurring (e.g., since the A1 measurement report includes a nonzero power level for the PCI of X) but may not take action since the power level does not satisfy the collision threshold. This may conserve resources and reduce network interruption due to unnecessary reconfiguration of the PCI by the serving BS 702-1. In some aspects, the serving BS 702-1 may take action when any power level is identified in the A1 measurement report. For example, the collision threshold of the serving BS 702-1 may be set to the same value as the A1 measurement threshold of the UE 704.

As shown by reference number 720, the serving BS 702-1 may detect a PCI collision with regard to the UE 704 based at least in part on the power level identified by the A1 measurement report. For example, the serving BS 702-1 may determine that the power level satisfies the collision threshold, and may therefore detect the PCI collision. Additionally, or alternatively, the serving BS 702-1 may detect the PCI collision based at least in part on receiving the A1 measurement report (e.g., in a case where the collision threshold is equal to the A1 measurement threshold). As further shown, the serving BS 702-1 may reset the serving BS 702-1 so that a PCI of the serving BS 702-1 is updated. In this way, the serving BS 702-1 detects a PCI collision at a higher rate of reliability than a BLER/CQI PCI collision detection process and causes a PCI of the serving BS 702-1 to be updated accordingly.

In some aspects, the serving BS 702-1 may cause the colliding BS 702-2 to change the PCI of the colliding BS 702-2. For example, the serving BS 702-1 may provide a backhaul communication to the colliding BS 702-2. Additionally, or alternatively, the serving BS 702-1 may cause a network management device to change the PCI of the colliding BS 702-2. Additionally, or alternatively, the serving BS 702-1 may notify a network management device, and the network management device might determine which BS should be assigned a new PCI.

FIG. 7C shows an example of timing of transmissions by serving BS 702-1 and colliding BS 702-2, as well as measurements by UE 704. As shown by reference number 722, transmissions by the colliding BS 702-2 are shown using single diagonal hatching, and transmissions by the serving BS 702-1 are shown using double diagonal hatching. Furthermore, energy or signals detected by the UE 704 is shown with hatching corresponding to the BS that transmitted the detected energy or signals. As shown by reference number 724, in some aspects, the colliding BS 702-2 may transmit continuously (e.g., throughout time periods associated with STX and/or measurement by the UE 704). For example, the colliding BS 702-2 may not enter STX during the time periods in which the UE 704 performs measurements, which permits the serving BS 702-1 to identify the PCI collision associated with the colliding BS 702-2.

As shown by reference number 726, the serving BS 702-1 may not transmit during time periods in which the UE 704 is performing measurements to identify PCI collisions. For example, the serving BS 702-1 may enter STX during the time periods. The measurements performed by the UE 704 are shown by reference number 728. The time periods in which the serving BS 702-1 enters STX, and/or the time periods in which the UE 704 performs measurements, may include one or more subframes. For example, and as shown, the time periods in which the UE 704 performs measurements may be shorter than and included in the time periods in which the serving BS 702-1 enters STX, to reduce interference and allow the BS 702-1 and/or the UE 704 time to reconfigure appropriately. As further shown, the measurements may be performed over a measurement duration, which may be defined based on the time period information provided to the UE 704 by the serving base station 702-1.

FIGS. 7A-7C are provided as examples. Other examples are possible and may differ from what was described in connection with FIGS. 7A-7C.

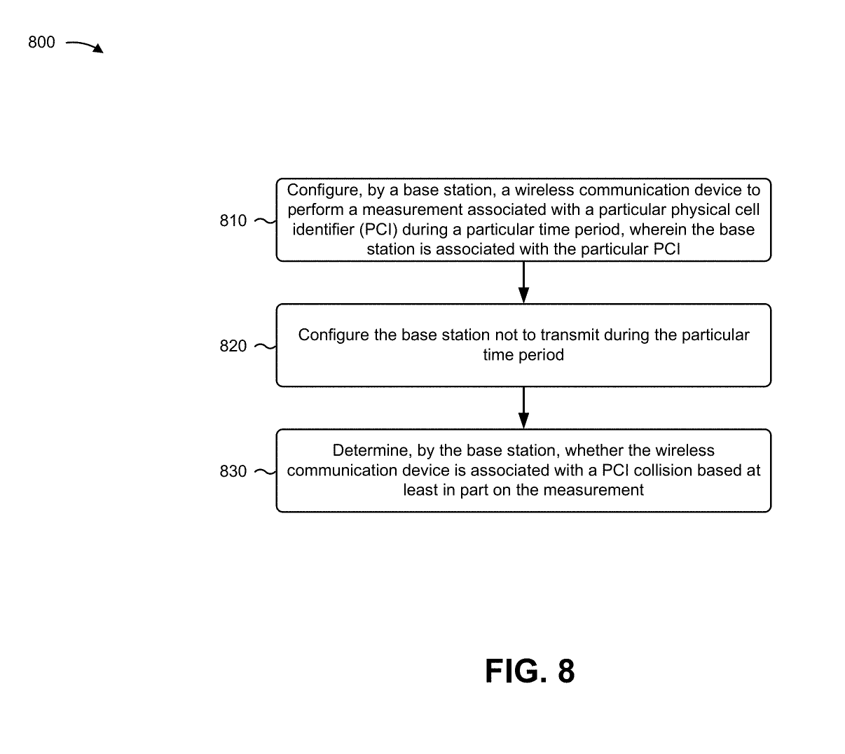

FIG. 8 is a flow chart 800 of a method of wireless communication. The method may be performed by a base station (e.g., the eNB 106, the eNB 204, the BS 702-1 or 702-2, the apparatus 902/902′, and/or the like).

At 810, the base station may configure a wireless communication device (e.g., a UE 102, 206, 650) to perform a measurement associated with a particular PCI during a particular time period. For example, the measurement may include an RSRP, an RSRQ, an RLM, and/or the like. The base station may provide a cell that is associated with the particular PCI, and the cell may cover the wireless communication device. The particular PCI may also be associated with another cell provided by a colliding base station that also covers the wireless communication device. The particular time period may include a subframe, a group of subframes, a pattern of subframes, and/or the like.

At 820, the base station may configure the base station not to transmit during the particular time period. For example, the base station may self-configure to enter an STX mode during the particular time period. In some aspects, the base station may self-configure to enter the STX mode for a longer time than the particular time period. For example, the base station may provide a time buffer before and/or after the particular time period so that the base station and/or the wireless communication device can reconfigure without interrupting measurement and/or normal operation.

At 830, the base station may determine whether the wireless communication device is associated with a PCI collision based at least in part on the measurement. For example, the base station may determine whether energy detected by the wireless communication device in the particular time period satisfies a threshold (e.g., a collision threshold). When the energy satisfies the threshold, the base station may determine that a PCI collision has occurred, or that the PCI collision is sufficiently severe that action should be taken with regard to the PCI collision. Additionally, or alternatively, the base station may cause a new PCI to be assigned to the base station and/or the colliding base station (e.g., by causing the base station to be reset, by causing the colliding base station to be reset, and/or the like).

In some aspects, the base station is configured to configure the wireless communication device to perform the measurement during the particular time period based at least in part on detecting a suspected PCI collision of the wireless communication device. In some aspects, the measurement is provided to the base station using an A1 measurement report.

In some aspects, configuring the base station not to transmit during the particular time period comprises configuring the base station to enter a suspended transmission (STX) mode while the measurement is performed. In some aspects, the measurement identifies energy information that identifies an energy level associated with the particular PCI. In some aspects, the base station is configured to compare the energy information to a threshold, wherein the base station is configured to determine that the wireless communication device is associated with a PCI collision when the energy information in the measurement report satisfies the threshold, and wherein the base station is configured to determine that the wireless communication device is not associated with a PCI collision when the energy information in the measurement report does not satisfy the threshold.

In some aspects, the base station is configured to configure multiple wireless communication devices to perform respective measurements for the particular time period, wherein the base station is configured to determine whether the wireless communication device is associated with a PCI collision based at least in part on the respective measurements. In some aspects, the wireless communication device is selected based at least in part on the wireless communication device being capable of performing measurements in the particular time period based at least in part on a time domain measurement resource restriction pattern.

In some aspects, the base station is configured to identify, to the wireless communication device, one or more subframes during which to perform the measurement associated with the particular PCI, wherein the one or more subframes are identified using a time domain measurement resource restriction pattern.

In some aspects, the base station is configured to periodically configure the wireless communication device to perform the measurement. In some aspects, the base station is configured to determine when to configure the wireless communication device to perform the measurement based at least in part on a downlink block error rate and/or a channel quality indicator. In some aspects, the base station is a first base station, and the measurement relates to transmissions by a second base station during the particular time period.

Although FIG. 8 shows example blocks of a method of wireless communication, in some aspects, the method may include additional blocks, fewer blocks, different blocks, or differently arranged blocks than those shown in FIG. 8. Additionally, or alternatively, two or more blocks shown in FIG. 8 may be performed in parallel.

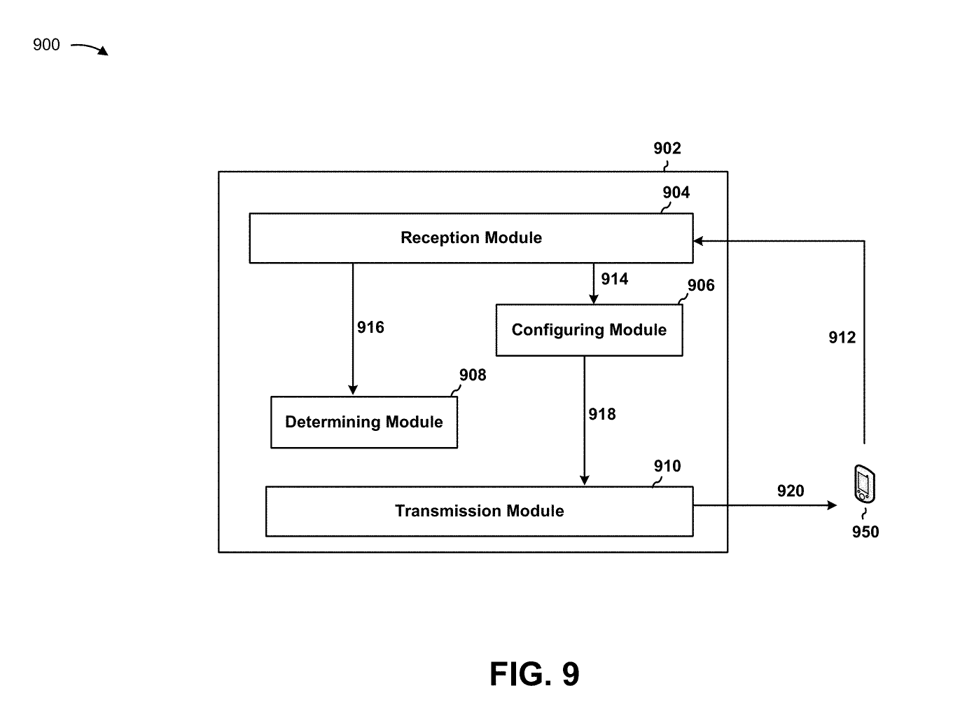

FIG. 9 is a conceptual data flow diagram 900 illustrating the data flow between different modules/means/components in an example apparatus 902. The apparatus 902 may be an eNB (e.g., the eNB 106, 204, BS 702-1, BS 702-2, and/or the like). In some aspects, the apparatus 1102 includes a reception module 904, a configuring module 906, a determining module 908, and/or a transmission module 910.

The reception module 904 may receive signals 912 from a wireless communication device 950 (e.g., a UE 102, 206, 704, and/or the like). The signals 912 may include uplink traffic, reference signals, measurement reports, an indication that the wireless communication device 950 is associated with a suspected PCI collision, and/or the like. The reception module 904 may process the signals 912, and may provide data 914 to the configuring module 906 based at least in part on the signals 912. The data 914 may identify a suspected PCI collision and/or the like. Additionally, or alternatively, the reception module 904 may provide data 916 based at least in part on the signals 912 to the determining module 908. The data 916 may include measurement information that the determining module may use to determine whether a PCI collision is detected.

The configuring module 906 may configure the apparatus 902 not to transmit during a particular time period based at least in part on the data 914. Additionally, or alternatively, the configuring module 906 may configure the wireless communication device 950 to perform a measurement associated with a particular PCI during the particular time period based at least in part on the data 914. For example, the configuring module 906 may configure one or more components of the apparatus 902 or another base station (e.g., transmission module 910, and/or the like) by providing data 918 identifying the configuration. Additionally, or alternatively, the configuring module 906 may cause one or more components of the wireless communication device 950 to be configured. For example, the configuring module 906 may provide data 918 to the transmission module 910 to cause the wireless communication device 950 to be configured. The transmission module 910 may transmit the data 918 as signals 920 (e.g., RRC signals and/or the like).

The determining module 908 may determine whether a PCI collision has occurred, and/or whether an action is to be taken with regard to a detected PCI collision, based at least in part on the data 916. For example, the determining module 908 may compare energy information or an energy level identified by the data 916 to a threshold to determine whether the PCI collision is detected and/or action is to be taken. In some aspects, the determining module 908 may cause one or more modules and/or the apparatus 902 to be reconfigured (e.g., to cause a new PCI to be assigned to the apparatus 902).

The apparatus may include additional modules that perform each of the blocks of the algorithm in the aforementioned flow chart of FIG. 9. As such, each block in the aforementioned flow chart of FIG. 9 may be performed by a module and the apparatus may include one or more of those modules. The modules may be one or more hardware components specifically configured to carry out the stated processes/algorithm, implemented by a processor configured to perform the stated processes/algorithm, stored within a computer-readable medium for implementation by a processor, or some combination thereof.

The number and arrangement of modules shown in FIG. 9 are provided as an example. In practice, there may be additional modules, fewer modules, different modules, or differently arranged modules than those shown in FIG. 9. Furthermore, two or more modules shown in FIG. 9 may be implemented within a single module, or a single module shown in FIG. 9 may be implemented as multiple, distributed modules. Additionally, or alternatively, a set of modules (e.g., one or more modules) shown in FIG. 9 may perform one or more functions described as being performed by another set of modules shown in FIG. 9.

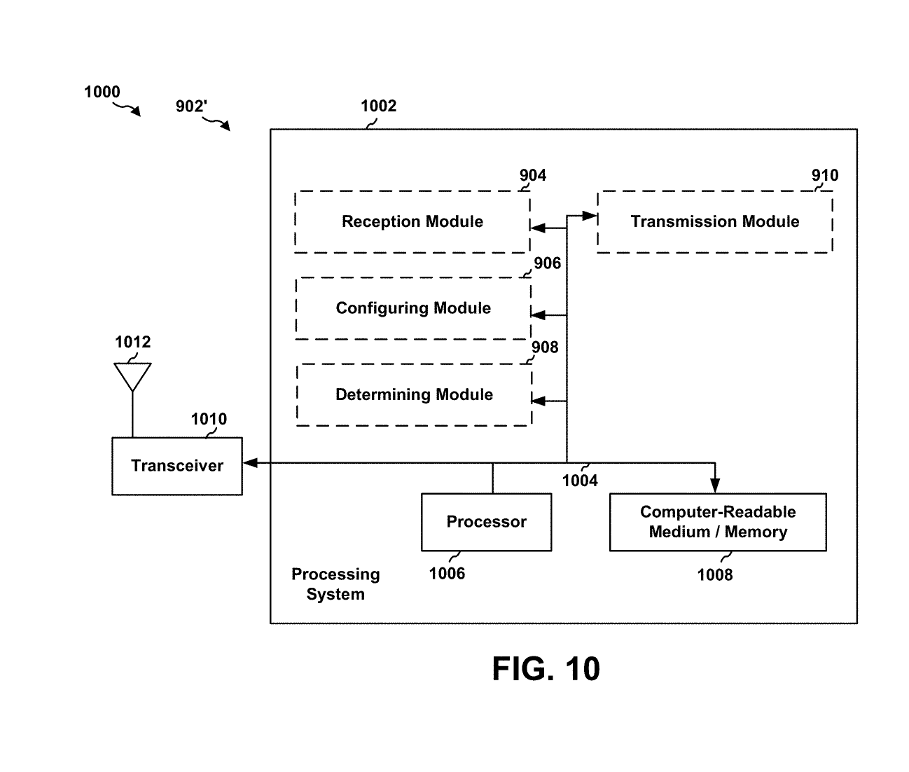

FIG. 10 is a diagram 1000 illustrating an example of a hardware implementation for an apparatus 902′ employing a processing system 1002. The apparatus 902′ may be reception module 904, configuring module 906, determining module 908, and transmission module 910.

The processing system 1002 may be implemented with a bus architecture, represented generally by the bus 1004. The bus 1004 may include any number of interconnecting buses and bridges depending on the specific application of the processing system 1002 and the overall design constraints. The bus 1004 links together various circuits including one or more processors and/or hardware modules, represented by the processor 1006, the modules 904, 906, 908, and 910, and the computer-readable medium/memory 1008. The bus 1004 may also link various other circuits such as timing sources, peripherals, voltage regulators, and power management circuits, which are well known in the art, and therefore, will not be described any further.

The processing system 1002 may be coupled to a transceiver 1010. The transceiver 1010 is coupled to one or more antennas 1012. The transceiver 1010 provides a means for communicating with various other apparatus over a transmission medium. The transceiver 1010 receives a signal from the one or more antennas 1012, extracts information from the received signal, and provides the extracted information to the processing system 1002, reception module 904. In addition, the transceiver 1010 receives information from the processing system 1002, transmission module 910, and based at least in part on the received information, generates a signal to be applied to the one or more antennas 1012. The processing system 1002 includes a processor 1006 coupled to a computer-readable medium/memory 1008. The processor 1006 is responsible for general processing, including the execution of software stored on the computer-readable medium/memory 1008. The software, when executed by the processor 1006, causes the processing system 1002 to perform the various functions described supra for any particular apparatus. The computer-readable medium/memory 1008 may also be used for storing data that is manipulated by the processor 1006 when executing software. The processing system further includes at least one of the modules 904, 906, 908, and 910. The modules may be software modules running in the processor 1006, resident/stored in the computer-readable medium/memory 1008, one or more hardware modules coupled to the processor 1006, or some combination thereof. The processing system 1002 may be a component of the eNB 610 and may include the memory 676 and/or at least one of the TX processor 616, the RX processor 670, and/or the controller/processor 675.

In some aspects, the apparatus 902/902′ for wireless communication includes means for configuring a wireless communication device to perform a measurement associated with a particular physical cell identifier (PCI) during a particular time period; means for configuring the apparatus 902/902′ not to transmit during the particular time period; and means for determining whether the wireless communication device is associated with a PCI collision based at least in part on the measurement. The aforementioned means may be one or more of the aforementioned modules of the apparatus 902 and/or the processing system 1002 of the apparatus 902′ configured to perform the functions recited by the aforementioned means. As described supra, the processing system 1002 may include the TX processor 616, the RX processor 670, and the controller/processor 675. As such, in one configuration, the aforementioned means may be the TX processor 616, the RX processor 670, and the controller/processor 675 configured to perform the functions recited by the aforementioned means.

It is understood that the specific order or hierarchy of blocks in the processes/flow charts disclosed is an illustration of example approaches. Based upon design preferences, it is understood that the specific order or hierarchy of blocks in the processes/flow charts may be rearranged. Further, some blocks may be combined or omitted. The accompanying method claims present elements of the various blocks in a sample order, and are not meant to be limited to the specific order or hierarchy presented.

Some implementations are described herein in connection with thresholds. As used herein, satisfying a threshold may refer to a value being greater than the threshold, more than the threshold, higher than the threshold, greater than or equal to the threshold, less than the threshold, fewer than the threshold, lower than the threshold, less than or equal to the threshold, equal to the threshold, and/or the like.

The previous description is provided to enable any person skilled in the art to practice the various aspects described herein. Various modifications to these aspects will be readily apparent to those skilled in the art, and the generic principles defined herein may be applied to other aspects. Thus, the claims are not intended to be limited to the aspects shown herein, but is to be accorded the full scope consistent with the language claims, wherein reference to an element in the singular is not intended to mean “one and only one” unless specifically so stated, but rather “one or more.” The word “exemplary” is used herein to mean “serving as an example, instance, or illustration.” Any aspect described herein as “exemplary” is not necessarily to be construed as preferred or advantageous over other aspects. Unless specifically stated otherwise, the term “some” refers to one or more. Combinations such as “at least one of A, B, or C,” “at least one of A, B, and C,” and “A, B, C, or any combination thereof” include any combination of A, B, and/or C, and may include multiples of A, multiples of B, or multiples of C. Specifically, combinations such as “at least one of A, B, or C,” “at least one of A, B, and C,” and “A, B, C, or any combination thereof” may be A only, B only, C only, A and B, A and C, B and C, or A and B and C, where any such combinations may contain one or more member or members of A, B, or C. All structural and functional equivalents to the elements of the various aspects described throughout this disclosure that are known or later come to be known to those of ordinary skill in the art are expressly incorporated herein by reference and are intended to be encompassed by the claims. Moreover, nothing disclosed herein is intended to be dedicated to the public regardless of whether such disclosure is explicitly recited in the claims. No claim element is to be construed as a means plus function unless the element is expressly recited using the phrase “means for.”

What is claimed is:

1. A method of wireless communication, comprising:
configuring, by a base station, a wireless communication device to perform a measurement associated with a particular physical cell identifier (PCI) during a particular time period,
wherein the base station is associated with the particular PCI;
configuring the base station not to transmit during the particular time period; and
determining, by the base station, whether the wireless communication device is associated with a PCI collision based at least in part on the measurement.

2. The method of claim 1, wherein the base station is a first base station, and
wherein the measurement relates to transmissions by a second base station during the particular time period.

3. The method of claim 1, wherein the base station is configured to configure the wireless communication device to perform the measurement during the particular time period based at least in part on detecting a suspected PCI collision of the wireless communication device.

4. The method of claim 1, wherein the measurement is provided to the base station using an A1 measurement report.

5. The method of claim 1, wherein configuring the base station not to transmit during the particular time period comprises configuring the base station to enter a suspended transmission (STX) mode while the measurement is performed.

6. The method of claim 1, wherein the measurement identifies energy information that identifies an energy level associated with the particular PCI; and
wherein the base station is configured to determine that the wireless communication device is associated with a PCI collision when the energy information satisfies a threshold, or
wherein the base station is configured to determine that the wireless communication device is not associated with a PCI collision when the energy information does not satisfy the threshold.

7. The method of claim 1, wherein the base station is configured to configure multiple wireless communication devices, including the wireless communication device, to perform respective measurements for the particular time period; and
wherein the base station is configured to determine whether the wireless communication device is associated with a PCI collision based at least in part on the respective measurements.

8. The method of claim 1, wherein the wireless communication device is selected based at least in part on the wireless communication device being capable of performing measurements in the particular time period based at least in part on a time domain measurement resource restriction pattern.

9. The method of claim 1, wherein the base station is configured to identify, to the wireless communication device, one or more subframes during which to perform the measurement associated with the particular PCI,
wherein the one or more subframes are identified using a time domain measurement resource restriction pattern.

10. The method of claim 1, wherein the base station is configured to periodically configure the wireless communication device to perform the measurement.

11. The method of claim 1, wherein the base station is configured to determine when to configure the wireless communication device to perform the measurement based at least in part on a downlink block error rate and/or a channel quality indicator.

12. A base station for wireless communication, comprising:
a memory; and
at least one processor coupled to the memory and configured to:
configure a wireless communication device to perform a measurement associated with a particular physical cell identifier (PCI) during a particular time period,
wherein the base station is associated with the particular PCI;
configure the base station not to transmit during the particular time period; and
determine whether the wireless communication device is associated with a PCI collision based at least in part on the measurement.

13. The base station of claim 12, wherein the base station is configured to configure the wireless communication device to perform the measurement during the particular time period based at least in part on detecting a suspected PCI collision of the wireless communication device.

14. The base station of claim 12, wherein the measurement is provided to the base station using an A1 measurement report.

15. The base station of claim 12, wherein the base station is configured to enter a suspended transmission (STX) mode while the measurement is performed.

16. The base station of claim 12, wherein the wireless communication device is selected based at least in part on the wireless communication device being capable of performing measurements in the particular time period based at least in part on a time domain measurement resource restriction pattern.

17. The base station of claim 12, wherein the base station is configured to identify, to the wireless communication device, one or more subframes during which to perform the measurement associated with the particular PCI,
wherein the one or more subframes are identified using a time domain measurement resource restriction pattern.

18. The base station of claim 12, wherein the base station is configured to determine when to configure the wireless communication device to perform the measurement based at least in part on a downlink block error rate and/or a channel quality indicator.

19. The base station of claim 12, wherein the base station is a first base station; and
wherein the measurement relates to transmissions by a second base station during the particular time period.

20. The base station of claim 12, wherein the base station is configured to configure multiple wireless communication devices to perform respective measurements for the particular time period; and
wherein the base station is configured to determine whether the wireless communication device is associated with a PCI collision based at least in part on the respective measurements.

21. An apparatus for wireless communication, comprising:
means for configuring a wireless communication device to perform a measurement associated with a particular physical cell identifier (PCI) during a particular time period,
wherein the apparatus is associated with the particular PCI;
means for configuring the apparatus not to transmit during the particular time period; and
means for determining whether the wireless communication device is associated with a PCI collision based at least in part on the measurement.

22. The apparatus of claim 21, wherein the apparatus is configured to configure the wireless communication device to perform the measurement during the particular time period based at least in part on detecting a suspected PCI collision of the wireless communication device.

23. The apparatus of claim 21, wherein the measurement is provided to the apparatus using an A1 measurement report.

24. The apparatus of claim 21, wherein the apparatus is configured to enter a suspended transmission (STX) mode while the measurement is performed.

25. The apparatus of claim 21, wherein the wireless communication device is selected based at least in part on the wireless communication device being capable of performing measurements in the particular time period based at least in part on a time domain measurement resource restriction pattern.

26. The apparatus of claim 21, wherein the apparatus is configured to identify, to the wireless communication device, one or more subframes during which to perform the measurement associated with the particular PCI,
wherein the one or more subframes are identified using a time domain measurement resource restriction pattern.

27. The apparatus of claim 21, wherein the apparatus is configured to periodically configure the wireless communication device to perform the measurement.

28. A non-transitory computer-readable medium storing computer executable code for wireless communication, comprising code for:
configuring, by a base station, a wireless communication device to perform a measurement associated with a particular physical cell identifier (PCI) during a particular time period,
wherein the base station is associated with the particular PCI; and
configuring the base station not to transmit during the particular time period; and
determining, by the base station, whether the wireless communication device is associated with a PCI collision based at least in part on the measurement.

29. The non-transitory computer-readable medium of claim 28, wherein the base station is a first base station, and
wherein the measurement relates to transmissions by a second base station during the particular time period.

30. The non-transitory computer-readable medium of claim 28, wherein the base station is configured to configure the wireless communication device to perform the measurement during the particular time period based at least in part on detecting a suspected PCI collision of the wireless communication device.
